(19) United States
(12) Patent Application Publication
(10) Pub. No.: US 2012/0257545 A1
(43) Pub. Date: Oct. 11, 2012

(54) METHOD FOR THE QUALITATIVE ROUTING IN A MULTI-HOP COMMUNICATION NETWORK, AND NETWORK NODE MANAGEMENT FACILITY

(75) Inventors: Khaldoun Al Agha, Paris (FR); Ignacy Gawedzki, Orsay (FR)

(73) Assignee: UNIVERSITE PARIS SUD 11, Orsay (FR)

(21) Appl. No.: 13/515,078

(22) PCT Filed: Dec. 10, 2010
(86) PCT No.: PCT/FR10/52669

§ 371 Date: Jun. 11, 2012

(30) Foreign Application Priority Data
Dec. 11, 2009 (FR) 0958890

(51) Int. Cl. H04W 84/18

(52) U.S. Cl. 370/255

(57) ABSTRACT

A method for the qualitative routing of data in an ad hoc multi-hop communication network makes it possible to determine, on the basis of a determinable communication quality criterion, at least one path for the passage of the data through links between nodes, the links being capable of mutually interfering during the passage of the data. According to the invention, in order to determine the path, the intra-flow interference is taken into account, and a step of determining overall network topology and a step of determining the interfering links are implemented, the latter step being implemented by determining a conflict graph. The path is obtained by resolving a linear system with completeness constraints.

The present invention relates to a method for calculating a path with a determined quality of service in a multi-hop network, as well as a network node management system. It has applications in the field of the management of data exchanges over communication networks, in particular for real-time multimedia applications over wireless ad hoc networks, voice over ad hoc network, videoconferencing over ad hoc network. It makes possible for such applications to coexist with other classical applications such as the web, the file transfer, etc.

The routing consists in finding a path between a source node and a destination node in a network. This path will be taken by data packets addressed to the destination. A path is a series of links. A link is a physical connection that links two neighbouring nodes of the network. A metric on a link is a value associated with the state of the link at a given instant of time. A metric on a path is a combination (addition, multiplication, minimum, or any other function) of the metrics on each link that make up the path.

An application may need that the packets it exchanges over the network take paths whose level of quality of service is sufficient. As used herein, “quality of service” means a set of measurable values characterizing a link between a source and a destination in a network, such as, for example, the transmission delay, the maximum data rate possible, the packet loss rate, etc.

For that purpose, it is necessary to calculate paths that offer a satisfying level of quality of service. Thus, when applications communicate with each other through the network, the data packets exchanged take paths that offer such applications the level of quality of service required for their operation.

Conventionally, in a wired network, a metric on a link is often independent of the state of other links, which makes it easy to estimate. On the contrary, in a wireless network, the state of a link depends far more often on that of the other links. It results that the metric on the link is more difficult to estimate in the wireless network.

Generally one or more metrics are used in the routing said “with quality of service”, wherein the matter is to find a path fulfilling the value required by an application for each of these metrics.

The existing routing algorithms ignore the impact of the use of a path on these metrics. By passing through it, a packet modifies the state of a link, and this modification is not considered in the initial calculation of the path in the conventional methods, which may lead to an unsatisfying result. Indeed, the existing approaches for the calculation of a path with a quality of service are based on the supposition that a metric on a link is modified only by the data packets that pass through it. The experience in the wireless networks shows that this supposition is wrong in most cases.

In particular, routing methods are known by the documents US2006/227724 and US2002/036987, but they suffer from certain limitations.

The present invention proposes that the estimation of the metrics is not separated from the calculation of the path itself, because the metrics of a link also depend on the other links that make up the calculated path. Therefore, to calculate paths that offer a satisfying level of quality of service, the interference generated on the path itself by the packets that pass through it is taken into account.

Thanks to the implementation of the invention, the calculated paths satisfactorily fulfill the requirements of the applications that use them, because the level of quality of service they offer is sufficient. Consequently, the applications can operate correctly. This possibility to use paths with a sufficient quality of service ensures that the communications between the applications that take the calculated paths do not use more resources that those offered by the network. The saturation of the network is thus avoided. Finally, in a general manner, the resources offered by the network are better shared by the applications, so that the coexistence of applications with different requirements becomes possible.

Accordingly, the invention relates to a method for the qualitative routing of data in an ad hoc multi-hop communication network, said method making it possible to determine, on the basis of a determinable communication quality criterion, at least one path for the passage of the data through links between nodes, between a source node and a destination node of said network, the quality criterion value of a given path being calculable based on at least one determinable metric of links in said network, the links being capable of interfering with each other during the passage of the data. According to the invention, in the determination of the path, the intra-flow interference is taken into account and, as a communication quality criterion that is a minimal value B of bandwidth to be satisfied, an ad hoc network routing protocol is used to determine the overall topology of the network and, given a parameter H>1, the interfering links are determined as follows:
each node of the network determines an overall conflict graph, defined as follows: each vertex of this overall conflict graph represents a link in a partial overall topology and each edge of this overall conflict graph represents a conflict relation between two links of the partial overall topology, that is to say that these links are separated by at most H hops according to the partial overall topology;

each node having an overall conflict graph determines the maximum full sub-graphs, called “cliques”, of the overall conflict graph, and said node determines the passage path in the network, in particular by solving the following linear system with the following integrality constraints:

$$Min \cdot {\sum }_{( i , j ) ∈ E} {x}_{i , j}$$

$$s . t . \\ \{ \begin{matrix}{\sum }_{( s , j ) ∈ E} {x}_{sj} - {\sum }_{( j , s ) ∈ E} {x}_{js} = 1 & \\ {\sum }_{( t , j ) ∈ E} {x}_{tj} - {\sum }_{( j , t ) ∈ E} {x}_{jt} = 1 & \\ {\sum }_{( i , j ) ∈ E} {x}_{ij} - {\sum }_{( j , i ) ∈ E} {x}_{ji} = 1 & ∀ i ∉ \{ s , t \} \\ {\sum }_{( i , j ) ∈ c} ( \frac{B}{{C}_{ij}} \cdot {x}_{ij} + {B}_{ij} ) \leq 1 & ∀ c ∈ K\end{matrix} \\ {x}_{ij} ∈ \{ 0 , 1 \} ∀ ( i , j ) ∈ E$$

where K is the set of cliques of the overall conflict graph, considering that s is a source node, t a destination node, and i, j reference indices of the network nodes, Cᵢⱼ the no-load data rate capacity of the link between the nodes i and j, Bᵢⱼ the proportion of the no-load capacity that is used on the link between the nodes i and j for the existing flows and the difference of Bᵢⱼ with respect to 1 thus corresponds to the proportion of usable free flow that remains with respect to the no-load capacity on said link (i, j), E being the set of links between the nodes.

In various embodiments of the invention, the following means are used, which can be considered individually or in any technically possible combination:
in the step of determining the overall topology of the network, a full local topology of the network is determined,
in the step of determining the overall topology of the network, a partial overall topology of the network is determined,
in the step of determining the overall topology of the network, the latter is determined as follows:
   each node of the network determines a full local topology of the network comprising, on the one hand, all the nodes corresponding to its direct neighbours, referred to as “one-hop”, and all the direct neighbours of its direct neighbours, then referred to as “two-hop”, and on the other hand, all the links between itself and its one-hop neighbours and between its one-hop neighbours and their own one-hop neighbours; said topology being called a two-hop full local topology,
   each node determines a sub-set of its neighbours, referred to as “MPR”, which permit it to join all its two-hop neighbours and communicates periodically to its one-hop neighbours the list of the neighbour(s) that has/have been determined as MPR;
   each node that has been determined as MPR by at least one neighbour broadcasts periodically on the network the list of the neighbour(s) that has/have been chosen as MPR, said list being called the “MPR-S” list;
   by aggregating the MPR-S lists, each node reconstructs a partial overall topology of the network comprising all the nodes and a set of links between the nodes permitting to find a least one path toward each other node of the network,
the ad hoc network routing protocol used is OLSR, AODV, DSR, TBRPF, or FSR,
the steps of determining the partial overall topology of the network and the conflict graph are performed separately within a node, the conflict graph being determined after the determination of the partial overall topology of the network.
the no-load capacity of each link adjacent to a node is determined by a method that effectively takes into account the conflicts existing between the neighbouring links,
the proportion of no-load capacity used by the existing links is determined by a method based on counting the quantity of data sent on each link by time unit,
the network is a radio wireless network,
for the determination of the maximum full sub-graphs, either an exact algorithm, such as the Bron-Kerbosch algorithm (1973), or an approaching method is used,
the values of the no-load capacities as well as the proportion of the no-load capacity used for each MPR-S are introduced into the control messages TC of the OLSR protocol.

The invention also relates to an ad hoc multi-hop communication network node management system that is specially configured to operate according to the method described.

The present invention will now be exemplified, without being limited, by the following description of embodiments and implementations, with reference to:

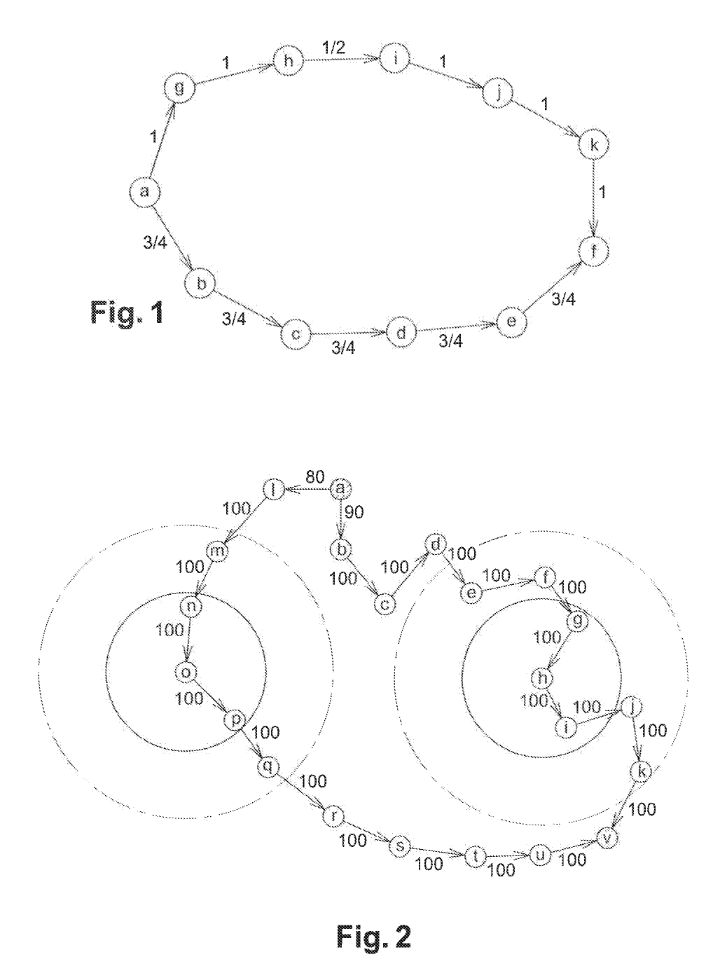

FIG. 1, which is a diagram of an exemplary wireless communication network with nodes and two paths between the starting node a and destination node v,

FIG. 2, which is a diagram of another exemplary wireless communication network with nodes and two paths between the starting node a and destination node f.

By way of exemplary embodiment, a calculation of the capacity of a path based on the capacities of the different links between nodes making up the path will be presented. A node is at least a receiving and relaying system comprising calculation means for managing the flows that pass through it. In practice, the node may be either a system specifically dedicated to the network, or a system further ensuring other functions such as, for example, a microcomputer in a network of microcomputers. The node may receive data from one or several other nodes and relay it to one or several other nodes. The link between the nodes may be wired, but it is preferably wireless and in particular of the radio type. In an ad hoc network, the topology may change over time and the data path(s) may also change over time. The management of the paths is done in a distributed way, with each node participating to the management.

Let's consider for example the case of a source node that wants to start a video stream requiring a bandwidth of X bits/sec. With the existing models, the capacity of a path would be the minimum of the capacities proposed by the links. Moreover, the links are correlated and cannot transmit in parallel. Consequently, to have effectively the expected bandwidth, the path to be found for the X bits/sec would be in fact a path where the minimum, including the correlations, is higher than or equal to X.

In FIG. 2, an example is shown in which two possibilities exist for going from a source to a destination (a to v). The continuous-line circle represents the coverage area of the nodes h and o, and the dotted-line circle that of the interference areas.

When a node transmits on a link (for example, o to p), no other node in the interference areas of o and p can transmit. The available capacity on a link thus depends on the capacities used by the links, at least one end of which is in the interference area of at least one end of the link. By extension, the available capacity of a path depends on the capacities used by the links, at least one end of which is in the interference area of at least one end of at least one link of the path. Searching for satisfying paths by taking into account this phenomenon is therefore very complex and the existing solutions ignore this problem.

With the present invention, paths offering at least a given available capacity are determined, while taking into account the correlations between the capacities of the links. To that end, network management calculators execute calculation algorithms for this path determination. For that purpose, the network topology is determined, for example calculated by a proactive routing protocol as OLSR and the path satisfying the required bandwidth is returned. Several steps are performed:
grouping the links interfering with each other without the passing through of the data flow, then
selecting the path among the different possibilities, taking into account the intra-flow interference.

More precisely, the network topology is determined using a routing protocol for ad hoc networks. Among the existing protocols, the OLSR (“Optimized Link State Routing”) protocol for example may be used, which operates as follows:
the nodes exchange periodically HELLO messages containing the list of the neighbour nodes from which they have recently received a HELLO message;
by aggregating the information contained in the HELLO messages received, each node reconstructs in memory a full local topology of the network, containing all the direct neighbours, referred to as “one-hop”, and the neighbours of the neighbours, referred to as “two-hop”, and all the links between itself and its one-hop neighbours and between its one-hop neighbours and their own one-hop neighbours;
each node chooses a sub-set of its neighbours, referred to as “MPR” for “Multipoint Relays”, which permit it to join all its two-hop neighbours and reports in its HELLO messages which neighbour has been chosen as MPR;
each node that has been chosen as MPR by at least one neighbour broadcasts periodically on the network messages referred to as TC (“Topology Control”) containing the list of the neighbours that have chosen it as MPR, and referred to as “MPR-S” for “MPR-selectors”;
by aggregating the information contained in the TC messages, each node reconstructs in memory a partial overall topology of the network containing all the nodes and enough links between the nodes to make it possible finding a path to each node.

A parameter of the solution is the number of hops H below which two links share a same capacity resource (bandwidth). In wireless networks, as the nodes use a common radio medium, the links may not be all used at the same time.

The matter is thus to determine the sets of links in conflict for a common resource. For that purpose, each node maintains a conflict graph:
each vertex of the conflict graph represents a link of the partial overall topology;
each edge of the conflict graph represents a conflict relation between two links of the partial overall topology.

The cliques (maximum full sub-graphs) of the conflict graph represent the sets of links in conflict for a common capacity resource.

For determining the paths, the following method is implemented. Given a source node s, a destination node t and a minimal bandwidth B to be satisfied, a feasible path is solution of the linear program with the following integrality constraints:

$$Min \cdot {\sum }_{( i , j ) ∈ E} {x}_{i , j}$$

$$s . t . \\ \{ \begin{matrix}{\sum }_{( s , j ) ∈ E} {x}_{sj} - {\sum }_{( j , s ) ∈ E} {x}_{js} = 1 & \\ {\sum }_{( t , j ) ∈ E} {x}_{tj} - {\sum }_{( j , t ) ∈ E} {x}_{jt} = 1 & \\ {\sum }_{( i , j ) ∈ E} {x}_{ij} - {\sum }_{( j , i ) ∈ E} {x}_{ji} = 1 & ∀ i ∉ \{ s , t \} \\ {\sum }_{( i , j ) ∈ c} ( \frac{B}{{C}_{ij}} \cdot {x}_{ij} + {B}_{ij} ) \leq 1 & ∀ c ∈ K\end{matrix} \\ {x}_{ij} ∈ \{ 0 , 1 \} ∀ ( i , j ) ∈ E$$

where K is the set of cliques of the conflict graph, Cᵢⱼ the no-load capacity of the link (i, j), and Bᵢⱼ the portion of the no-load capacity already used.

To come back to FIG. 1, when applying these methods, considering a two-hop interference, the following set of cliques is obtained:

$$K = \{ \begin{matrix}\{ ( a , b ) , ( a , g ) , ( b , c ) \} \\ \{ ( a , b ) , ( a , g ) , ( g , h ) \} \\ \{ ( a , b ) , ( b , c ) , ( c , d ) \} \\ \{ ( b , c ) , ( c , d ) , ( d , e ) \} \\ \{ ( c , d ) , ( d , e ) , ( e , f ) \} \\ \{ ( d , e ) , ( e , f ) , ( k , f ) \} \\ \{ ( e , f ) , ( j , k ) , ( k , f ) \} \\ \{ ( a , g ) , ( g , h ) , ( h , i ) \} \\ \{ ( g , h ) , ( h , i ) , ( i , j ) \} \\ \{ ( h , i ) , ( i , j ) , ( j , k ) \} \\ \{ ( i , j ) , ( j , k ) , ( k , f ) \}\end{matrix} \}$$

The available capacity on the path (a, b, c, d, e, t) is obtained by searching for the maximum value R₀, such that:

$$\{ \begin{matrix}{B}_{ab} + {R}_{0} + {B}_{ag} + {B}_{bc} + {R}_{0} \leq 1 \\ {B}_{ab} + {R}_{0} + {B}_{ag} + {B}_{gh} \leq 1 \\ {B}_{ab} + {R}_{0} + {B}_{bc} + {R}_{0} + {B}_{cd} + {R}_{0} \leq 1 \\ {B}_{bc} + {R}_{0} + {B}_{cd} + {R}_{0} + {B}_{de} + {R}_{0} \leq 1 \\ {B}_{cd} + {R}_{0} + {B}_{de} + {R}_{0} + {B}_{ef} + {R}_{0} \leq 1 \\ {B}_{de} + {R}_{0} + {B}_{ef} + {R}_{0} + {B}_{kf} \leq 1 \\ {B}_{ef} + {R}_{0} + {B}_{jk} + {B}_{kf} \leq 1\end{matrix}$$

In FIG. 1, the numerical values indicated between the nodes correspond to the values of remaining/available capacity (i.e. 1−B . . . ). In the preceding list of inequalities, the B . . . are replaced by their values, and the following is obtained:

$$\{ \begin{matrix}{R}_{0} \leq 1 \text{/} 2 ( 1 \text{-} 1 \text{/} 4 \text{-} 1 \text{/} 4 ) = 1 \text{/} 4 \\ {R}_{0} \leq 1 \text{-} 1 \text{/} 4 = 3 \text{/} 4 \\ {R}_{0} \leq 1 \text{/} 3 ( 1 \text{-} 1 \text{/} 4 \text{-} 1 \text{/} 4 \text{-} 1 \text{/} 4 ) = 1 \text{/} 12 \\ {R}_{0} \leq 1 \text{/} 3 ( 1 \text{-} 1 \text{/} 4 \text{-} 1 \text{/} 4 \text{-} 1 \text{/} 4 ) = 1 \text{/} 12 \\ {R}_{0} \leq 1 \text{/} 3 ( 1 \text{-} 1 \text{/} 4 \text{-} 1 \text{/} 4 \text{-} 1 \text{/} 4 ) = 1 \text{/} 12 \\ {R}_{0} \leq 1 \text{/} 2 ( 1 \text{-} 1 \text{/} 4 \text{-} 1 \text{/} 4 ) = 1 \text{/} 4 \\ {R}_{0} \leq 1 \text{-} 1 \text{/} 4 = 3 \text{/} 4\end{matrix}$$

The maximum value R₀ that satisfies these equations is thus 1/12.

Likewise, the available capacity on (a, g, h, i, j, k, t) is calculated by searching for the maximum value R₁, such that:

$$\{ \begin{matrix}{B}_{ab} + {B}_{ag} + {R}_{1} + {B}_{bc} \leq 1 \\ {B}_{ab} + {B}_{ag} + {R}_{1} + {B}_{gh} + {R}_{1} \leq 1 \\ {B}_{de} + {B}_{ef} + {B}_{kf} + {R}_{1} \leq 1 \\ {B}_{ef} + {B}_{jk} + {R}_{1} + {B}_{kf} + {R}_{1} \leq 1 \\ {B}_{ag} + {R}_{1} + {B}_{gh} + {R}_{1} + {B}_{hi} + {R}_{1} \leq 1 \\ {B}_{gh} + {R}_{1} + {B}_{hi} + {R}_{1} + {B}_{ij} + {R}_{1} \leq 1 \\ {B}_{hi} + {R}_{1} + {B}_{ij} + {R}_{1} + {B}_{jk} + {R}_{1} \leq 1 \\ {B}_{ij} + {R}_{1} + {B}_{jk} + {R}_{1} + {B}_{kf} + {R}_{1} \leq 1\end{matrix}$$

Which gives, by replacing the B . . . by their values:

$$\{ \begin{matrix}{R}_{1} \leq ( 1 \text{-} 1 \text{/} 4 \text{-} 1 \text{/} 4 ) = 1 \text{/} 2 \\ {R}_{1} \leq 1 \text{/} 2 ( 1 \text{-} 1 \text{/} 4 ) = 3 \text{/} 8 \\ {R}_{1} \leq 1 \text{-} 1 \text{/} 4 \text{-} 1 \text{/} 4 = 1 \text{/} 2 \\ {R}_{1} \leq 1 \text{/} 2 ( 1 \text{-} 1 \text{/} 4 ) = 3 \text{/} 8 \\ {R}_{1} \leq 1 \text{/} 3 ( 1 \text{-} 1 \text{/} 2 ) = 1 \text{/} 6 \\ {R}_{1} \leq 1 \text{/} 3 ( 1 \text{-} 1 \text{/} 2 ) = 1 \text{/} 6 \\ {R}_{1} \leq 1 \text{/} 3 ( 1 \text{-} 1 \text{/} 2 ) = 1 \text{/} 6 \\ {R}_{1} \leq 1 \text{/} 3\end{matrix}$$

The maximum value R₁ that satisfies these equations is thus ⅙.

Therefore, with the method of the present invention, it may be calculated that the capacities of these two paths are respectively 1/12 and ⅙, which thus determines that the second path is the best in terms of capacity. On the other hand, the existing techniques would have selected the first path as the best one in terms of capacity.

In the calculations implemented for determining the paths fulfilling the quality criterion, metrics are used. These metrics may be the capacity in bits/sec, the number of hops separating a source from a destination, or the packet transmission delay from the source to the destination. These metrics may be combined between each other to define the quality criterion. An example of metric combination is:
finding the shorter path in number of hops, while satisfying the relation:

(End to end delay<y sec) and (Capacity>X bits/sec).

It is well understood that the invention may be adapted according to many other possibilities without thereby departing from the scope defined by the description and the claims.

1. A method for the qualitative routing of data in an ad hoc multi-hop communication network, said method making it possible to determine, on the basis of a determinable communication quality criterion, at least one path for the passage of the data through links between nodes, between a source node and a destination node of said network, the quality criterion value of the given path being calculable based on at least one determinable metric of links in said network, the links being capable of interfering with each other during the passage of the data,
characterized in that, in the determination of the path, the intra-flow interference is taken into account and, as a communication quality criterion that is a minimal value B of bandwidth to be satisfied, an ad hoc network routing protocol is used to determine the overall topology of the network, and in that, given a parameter H>1, the interfering links are determined as follows:
once the routing protocol is functional, each node of the network determines an overall conflict graph, wherein, in said conflict graph, each vertex represents a link in a partial overall topology and each edge of this overall conflict graph represents a conflict relation between two links of the partial overall topology, that is to say that these links are separated by at most H hops according to the partial overall topology;
each node having an overall conflict graph determines the maximum full sub-graphs, called “cliques”, of the overall conflict graph, and said node determines the passage path in the network by solving a linear system with integrality constraints.

2. A method according to claim 1, characterized in that the determination of the passage path in the network is obtained by solving the following linear system, with the following integrality constraints:
$$Min \cdot {\sum }_{( i , j ) ∈ E} {x}_{i , j}$$
$$s . t . \\ \{ \begin{matrix}{\sum }_{( s , j ) ∈ E} {x}_{sj} - {\sum }_{( j , s ) ∈ E} {x}_{js} = 1 & \\ {\sum }_{( t , j ) ∈ E} {x}_{tj} - {\sum }_{( j , t ) ∈ E} {x}_{jt} = 1 & \\ {\sum }_{( i , j ) ∈ E} {x}_{ij} - {\sum }_{( j , i ) ∈ E} {x}_{ji} = 1 & ∀ i ∉ \{ s , t \} \\ {\sum }_{( i , j ) ∈ c} ( \frac{B}{{C}_{ij}} \cdot {x}_{ij} + {B}_{ij} ) \leq 1 & ∀ c ∈ K\end{matrix} \\ {x}_{ij} ∈ \{ 0 , 1 \} ∀ ( i , j ) ∈ E$$
where K is the set of cliques of the overall conflict graph, considering that s is a source node, t a destination node, and i, j reference indices of the network nodes, Cᵢⱼ the no-load data rate capacity of the link between the nodes i and j, Bᵢⱼ the proportion of the no-load capacity that is used on the link between the nodes i and j for the existing flows and the difference of Bᵢⱼ with respect to 1 thus corresponds to the proportion of usable free flow that remains with respect to the no-load capacity on said link (i, j), E being the set of links between the nodes.

3. A method according to claim 1, characterized in that the ad hoc network routing protocol used is OLSR, AODV, DSR, TBRPF, or FSR.

4. A method according to claim 1, characterized in that the steps of determining the partial overall topology of the network and the conflict graph are performed separately within a node, the conflict graph being determined after the determination of the partial overall topology of the network.

5. A method according to claim 1, characterized in that the network is a radio wireless network.

6. A method according to claim 1, characterized in that, for the determination of the maximum full sub-graphs, a method chosen among the exact method of Bron-Kerbosch or an approaching method is used.

7. A method according to claim 3, characterized in that the routing protocol used is OLSR, in which the values of the no-load capacities as well as the proportion of the no-load capacity used for each MPR-S are introduced into the control messages TC.

8. An ad hoc multi-hop communication network node management system, characterized in that it is specially configured to operate according to the method of claim 1.

9. A method according to claim 2, characterized in that the ad hoc network routing protocol used is OLSR, AODV, DSR, TBRPF, or FSR.

10. A method according to claim 2 characterized in that the steps of determining the partial overall topology of the network and the conflict graph are performed separately within a node, the conflict graph being determined after the determination of the partial overall topology of the network.

11. A method according to claim 5 characterized in that the steps of determining the partial overall topology of the network and the conflict graph are performed separately within a node, the conflict graph being determined after the determination of the partial overall topology of the network.
